(19) United States
(12) Patent Application Publication
(10) Pub. No.: US 2026/0039382 A1
(43) Pub. Date: Feb. 5, 2026

(54) Changing Laser Scan for Satellite Acquisition

(71) Applicant: The Boeing Company, Arlington, VA (US)

(72) Inventor: Nathan D. Hiller, Irvine, CA (US)

(21) Appl. No.: 18/791,572

(22) Filed: Aug. 1, 2024

(51) Int. Cl. H04B 10/118

(52) U.S. Cl. CPC H04B 10/118

(57) ABSTRACT

A method for pointing a laser beam. The laser beam is directed at a central location in a search area in which a satellite is expected to be located. The laser beam is moved in a path from the central location to an outer location. A number of scan parameters is adjusted during movement of the laser beam on the path.

### CROSS-REFERENCE TO RELATED APPLICATIONS

This application is related to the following U.S. Patent Application entitled “Variable Scan Parameter Based Laser Sensor System,” Serial No. ______, attorney docket no. 23-1186-US-NP[2], and U.S. Patent Application entitled “Nonuniform Laser Beam Scan Based Flight Path Clearing System,” Serial No. ______, attorney docket no. 23-1186-US-NP[3], filed even date hereof, assigned to the same assignee, and incorporated herein by reference in its entirety.

### STATEMENT OF GOVERNMENT INTEREST

This invention was made with United States Government support. The United States Government has certain rights in the invention.

### 1. FIELD

The present disclosure relates generally to laser beams, in particular, to directing a laser beam at satellites to establish communications with the satellites.

### 2. BACKGROUND

Satellites can send information to each other using laser beams. With satellite communications, data can be transmitted as laser beams that are encoded with information. The laser beams can carry digital data in the form of on-and-off patterns when laser beam pulses are used. In other cases, the intensity or phase of laser beams can be changed to encode data.

In establishing satellite communications between two satellites, a laser beam is transmitted from one satellite to another satellite to establish a communications link. Establishing the communications link involves one satellite directing a laser beam at another satellite. The laser beam travels over great distances and scans an area in which the satellite is expected to establish the communications link.

### SUMMARY

An embodiment of the present disclosure provides a laser beam transmission system comprising a laser beam system configured to transmit a laser beam; and a controller. The controller is configured to control the laser beam system to direct the laser beam at a central location in a search area in which a satellite is expected to be located; move the laser beam on a path from the central location to an outer location; and adjust a number of scan parameters during movement of the laser beam on the path.

Another embodiment of the present disclosure provides an electromagnetic beam transmission system comprising an electromagnetic beam system configured to transmit an electromagnetic beam and a controller. The controller is configured to control the electromagnetic beam transmission system to direct the electromagnetic beam at a central location in a search area in which an object is expected to be located, move the electromagnetic beam on a path from the central location to an outer location, and adjust a number of scan parameters during movement of the electromagnetic beam on the path.

Still another embodiment of the present disclosure provides a method for pointing a laser beam. The laser beam is directed at a central location in a search area in which a satellite is expected to be located. The laser beam is moved in a path from the central location to an outer location. A number of scan parameters is adjusted during movement of the laser beam on the path.

Yet another embodiment of the present disclosure provides a method for pointing an electromagnetic beam. The electromagnetic beam is directed at a central location in a search area in which an object is expected to be located. The electromagnetic beam is moved on a path from the central location to an outer location. A number of scan parameters is adjusted during movement of the electromagnetic beam on the path.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial illustration of a satellite communications environment in which illustrative examples may be implemented;

FIG. 2 is an illustration of a block diagram of a search environment in accordance with an illustrative embodiment;

FIG. 3 is an illustration of a continuous spiral scan system in accordance with an illustrative environment;

FIG. 4 is an illustration of scan speed for a spiral scan in accordance with an illustrative embodiment;

FIG. 5 is an illustration of overlap in accordance with an illustrative embodiment;

FIG. 6 is an illustration of an overlap for a spiral scan in accordance with an illustrative embodiment;

FIG. 7 is an illustration of an overlap based on jumper distribution in accordance with an illustrative embodiment;

FIG. 8 is an illustration of an overlap based on jumper distribution in accordance with an illustrative embodiment;

FIG. 9 is an illustration of a flowchart of a process for pointing a laser beam in accordance with an illustrative embodiment;

FIG. 10 is an illustration of a flowchart of a process for establishing communications in accordance with an illustrative embodiment;

FIG. 11 is an illustration of a flowchart of a process for moving a laser beam in accordance with an illustrative embodiment;

FIG. 12 is an illustration of a flowchart of a process for adjusting a number of scan parameters in accordance with an illustrative embodiment;

FIG. 13 is an illustration of a flowchart of a process for adjusting a number of scan parameters in accordance with an illustrative embodiment;

FIG. 14 is an illustration of a flowchart of a process for adjusting a number of scan parameters in accordance with an illustrative embodiment;

FIG. 15 is an illustration of a flowchart of a process for pointing an electromagnetic beam in accordance with an illustrative embodiment;

FIG. 16 is an illustration of a block diagram of a search environment in accordance with an illustrative embodiment;

FIG. 17 is an illustration of a flowchart of a process for receiving electromagnetic signals in accordance with an illustrative embodiment;

FIG. 18 is an illustration of a flowchart of a process for moving a field of view in accordance with an illustrative embodiment;

FIG. 19 is an illustration of a flowchart of a process for halting movement of a field of view in accordance with an illustrative embodiment;

FIG. 20 is an illustration of a flowchart of a process for establishing communications in accordance with an illustrative embodiment;

FIG. 21 is an illustration of a flowchart of a process for detecting electromagnetic signals in accordance with an illustrative embodiment; and

FIG. 22 is an illustration of a block diagram of a data processing system in accordance with an illustrative embodiment.

### DETAILED DESCRIPTION

The illustrative embodiments recognize and take into account one or more different considerations as described herein. During the initial acquisition in establishing the communications link, a time efficient scanning method for pointing laser beams at satellites is desired. Various scanning methods can be used to point a laser beam from a transmitting satellite to a receiving satellite. In satellite communications, lasers beams can have different wavelengths such as, for example, a wavelength of about 1064 nm in the near infrared wavelength range, 1550 nm in the visible wavelength range, and 532 nm in the visible wavelength range.

With the distances separating satellites, establishing communications between the satellites using laser beams requires a time efficient scanning technique. The speed at which an area to be scanned to locate a satellite is important in establishing the communications link as quickly as possible. For example, a service-level agreement (SLA) may require establishing a communications link within a specified amount of time.

Using a most time efficient technique for scanning an area to locate a satellite is important in quickly establishing communications links between satellites using laser beams to meet service level agreements (SLAs) and other requirements or agreements.

Current laser scanning methods include a continuous spiral scan, a step spiral scan, a segment scan, and a raster scan. These types of scans for establishing the communications link may not be sufficiently fast to establish communications as quickly as needed to meet various requirements that may be present.

Currently, the different parameters for scanning a satellite are fixed during the entire scan. However, given the probability of finding a satellite typically changes from location to location, the scan parameters can be changed from location to location to efficiently search for the satellite. In some cases, the scan parameters can be changed between some locations and not all of the locations.

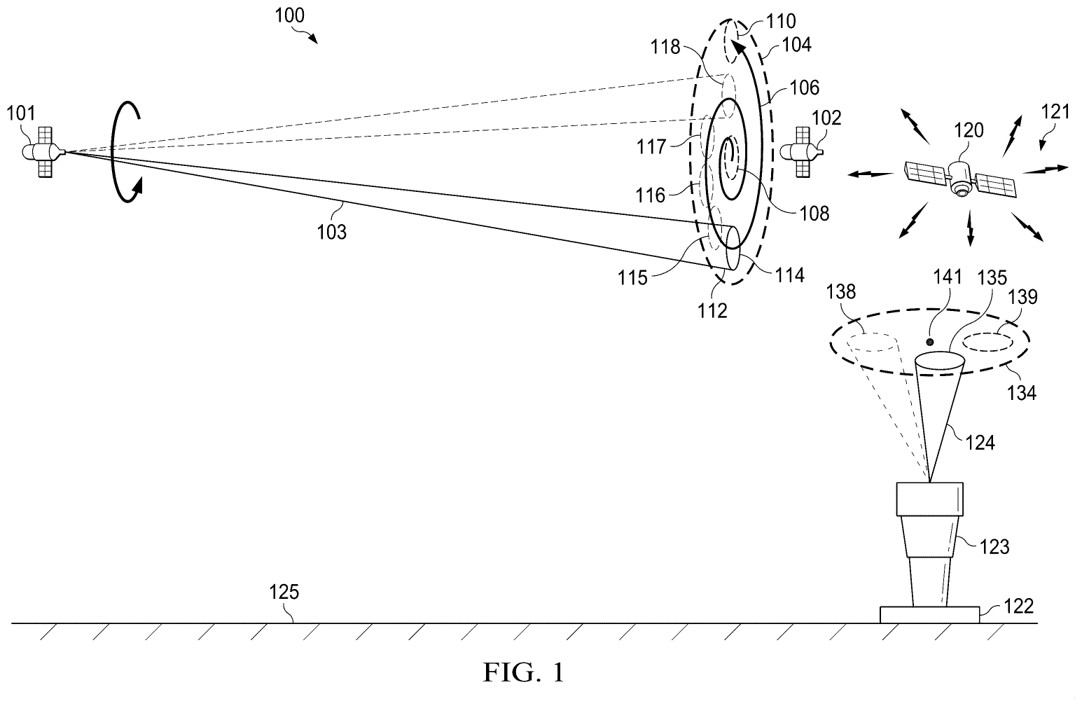

With reference now to the figures and, in particular, with reference to FIG. 1, a pictorial illustration of a satellite communications environment is depicted in which illustrative examples may be implemented. As depicted, satellite communications environment 100 is an environment in which electromagnetic signals such as laser beams can be transmitted for satellite communications.

For example, satellite 101 transmits laser beam 103 to satellite 102 to establish a communications link with satellite 102. With the establishment of a communications link, satellite 101 and satellite 102 can communicate information using laser beams. The transmission data using laser beams can be unidirectional from satellite 101 to satellite 102 or from satellite 102 to satellite 101. In another example, the communication of data using laser beams can be bidirectional between satellite 101 and satellite 102.

In this illustrative example, satellite 101 scans search area 104 using laser beam 103. The laser beam 103 is transmitted by satellite 101 using path 106 in search area 104. In this example, path 106 has a spiral pattern. In this example, the scan is a spiral scan with path 106 having a spiral pattern. This path is also referred to as spiral path. This scan is performed to locate satellite 102 within the search area 104. Satellite 102 can be located when satellite 102 receives laser beam 103 and transmits a response indicating that satellite 102 has received laser beam 103. In this example, satellite 102 can detect laser beam 103 using a positioning sensing detector. This positioning sensing detector can be a lateral effect position sensor, a quadrant position photodiode detector, a focal-plane array or some other sensor that can detect laser beam 103. The response transmitted by satellite 102 can be a laser beam, a radio frequency signal, a microwave signal, or some other medium in which a response can be transmitted.

In this illustrative example, satellite 102 is expected to be located within search area 104. Further, in this example, search area 104 is an area in satellite 102 that can be located. This area can be determined based on an estimated location of satellite 102. This estimate has uncertainty that can also be used to determine search area 104. The uncertainty in the location of a satellite can be a range of possible positions wherein the satellite may be located.

For example, the location uncertainty for a satellite is a result of the satellite navigation system's attitude and ephemeris uncertainties (hundreds of mrad), which are expressed as azimuth and elevation uncertainties. The probability distribution function for a satellite position can be described by a Gaussian distribution for both azimuth and elevation uncertainties. In addition to the uncertainty in satellite location, there is an uncertainty in the beam pointing location. This uncertainty can be a pointing error. Both the satellite location uncertainty and beam pointing error are accounted for in said Gaussian distribution.

As depicted, path 106 begins from central location 108 in search area 104 and ends at outer location 110 in search area 104. In this example, central location 108 is the maximum of a gaussian distribution that indicates the likelihood of satellite 102 being present.

As depicted, laser beam 103 covers beam spot 112 that covers location 114 on path 106. In this example, beam spot 112 has moved to location 114 from a previous location starting from central location 108. Examples of some previous locations on path 106 include location 115, location 116, location 117, and location 118.

This spiral scan is performed in a manner that is more efficient as compared to current techniques. For example, variability in the pointing of laser beam 103 can be caused by various conditions. For example, variability can be caused by vibrations in satellite 101. These vibrations can cause errors in performing a spiral scan of search area 104. For example, these vibrations can cause laser beam 103 to jump from the intended location to another location causing laser beam 103 to miss satellite 102. Current scanning techniques do recognize or make adjustments for this type of variability.

In this illustrative example, satellite 101 adjusts one or more scan parameters during movement of laser beam 103 on path 106 while performing a spiral scan of search area 104.

These scanning parameters can be selected from at least one of a scan speed for laser beam movement of laser beam 103, an amount of beam overlap of laser beam 103 between adjacent spirals in a spiral path, a scan speed, a beam divergence, or other parameters relating to laser beam 103 or the movement of laser beam 103.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

When satellite 102 is located by satellite 101, satellite 101 can hold scanning search area 104. Communications can be established between satellite 101 and satellite 102. The communications can be unidirectional or bidrectional. For example, satellite 101 can transmit information to satellite 102 using laser beam. In other examples, satellite 102 can also transmit information to satellite 101 using a laser beam.

Further, within satellite communications environment 100, satellite 120 broadcasts information in electromagnetic signals 121 that can be received by receiver 122. Electromagnetic signals 121 can be at least one of the electric or magnetic fields that carry information. At least one of amplitude, frequency, or both can be modulated to encode information in electromagnetic signals 121. In this illustrative example, telescope 123 is a component for receiver 122. As depicted in this example, these components are located on ground 125.

Telescope 123 is a physical device that can be used to transmit and receive signals. For example, telescope 123 includes optics and other components that can be used to collect and focus incoming electromagnetic signals such as light waves or radio waves. In this illustrative example, satellite 120 is expected to be within search area 134.

Telescope 123 has field of view (FOV) 124 that can be pointed at different locations in search area 134. In other words, telescope 123 has optics for other components that define field of view 124.

Field of view 124 for telescope 123 can be pointed at location 135 in search area 134. The selection of location 135 is based on central location 141 in of search area 134.

Field of view 124 can be moved from location 135 to location 138 using a path within search area 134. In this example, the path is a continuous path in the form of a spiral path.

This movement of the field of view 124 can continue to occur until receiver 122 detects electromagnetic signals 121 from satellite 120. In other illustrative examples, this process can be halted when some threshold amount of time occurs without detecting electromagnetic signals 121 or if the entire search area is searched without detecting electromagnetic signals 121. The search area and amount of time can be user set in one illustrative example.

In this illustrative example, electromagnetic signals 121 may be considered to be detected when receiver 122 is able to extract or identify information encoded in electromagnetic signals 121. In another example, electromagnetic signals 121 can be considered to be detected when electromagnetic signals 121 above a noise level are detected.

The illustration of satellite communications environment 100 is provided as one example and is not meant to limit the manner in which other illustrative examples can be implemented. Although search area 104 is shown as circular, this search area in which the satellites can be located can take other shapes. For example, search area 104 can be elliptical, or some other shape in the different examples. This search area can also be referred to as an uncertainty area in which satellite 102 can be located.

In another example, receiver 122 can move field of view 124 in a continuous path. This continuous path can be a spiral path similar to path 106, which is a spiral path, used to move beam spot 112.

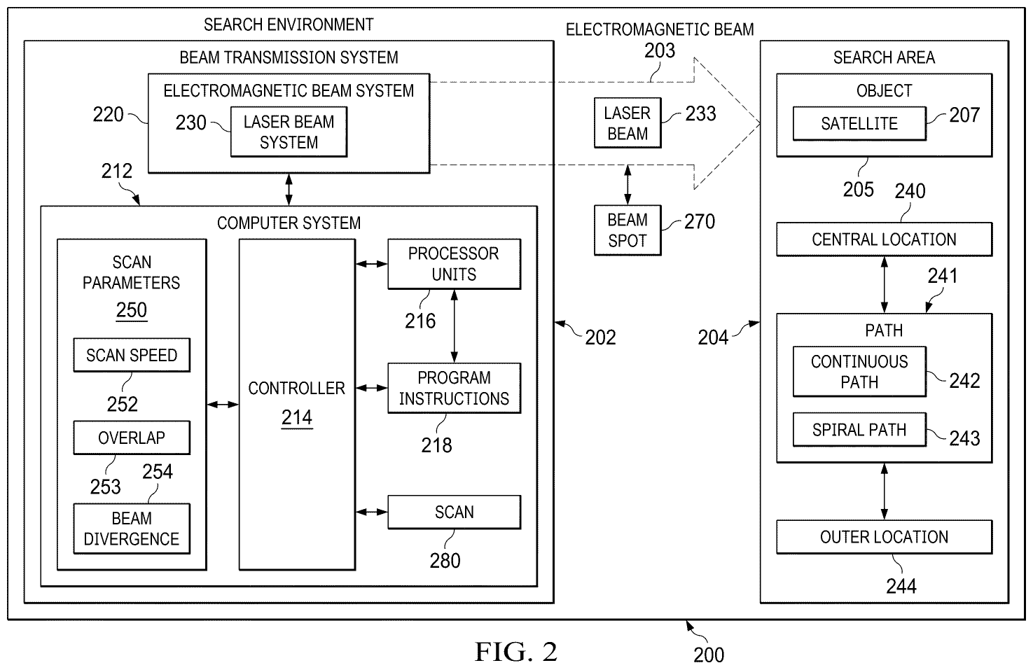

With reference now to FIG. 2, an illustration of a block diagram of a search environment is depicted in accordance with an illustrative embodiment. In this illustrative example, search environment 200 is an environment in which beam transmission system 202 operates to search for object 205 in search area 204 using electromagnetic beam 203. Search area 204 can have a number of different shapes. In this illustrative example, these shapes can be selected a group comprising a circle, an ellipse, or some other suitable shape.

Electromagnetic beam 203 can be selected from a group comprising a laser beam, a radio frequency beam, a microwave beam, and other types of electromagnetic signals that can be shaped into a beam. In this illustrative example, electromagnetic beam 203 is laser beam 233.

Object 205 can be selected from a group comprising a platform, a stationary platform, a land-based structure, an aquatic-based structure, a space-based structure, an aircraft, a vehicle controlled by artificial intelligence, a commercial aircraft, a rotorcraft, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a spacecraft, a space station, a satellite, a submarine, an automobile, a power plant, a bridge, a dam, a house, a manufacturing facility, a building, and other suitable objects. In this example, object 205 is satellite 207.

As depicted beam transmission system 202 comprises electromagnetic beam system 220 and controller 214. In this example, controller 214 is located in computer system 212. As depicted, computer system 212 is also part of beam transmission system 202.

Electromagnetic beam system 220 is a physical hardware system. This hardware system is configured to transmit electromagnetic beam 203. When electromagnetic beam 203 is laser beam 233, electromagnetic beam system 220 is implemented using laser beam system 230.

Controller 214 can be implemented in software, hardware, firmware, or a combination thereof. When software is used, the operations performed by controller 214 can be implemented in program instructions configured to run on hardware, such as a processor unit. When firmware is used, the operations performed by controller 214 can be implemented in program instructions and data can be stored in persistent memory to run on a processor unit. When hardware is employed, the hardware can include circuits that operate to perform the operations in controller 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer-readable program instructions.

As used herein, a processor unit in the number of processor units 216 is a hardware device and is comprised of hardware circuits such as those on an integrated circuit that respond to and process instructions and program code that operate a computer. When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, controller 214 transmission system controls the laser beam system 230 to direct laser beam 233 at central location 240 in search area 204 in which satellite 207 is expected to be located. Controller 214 also controls the laser beam system 230 to move the laser beam 233 on path 241 from central location 240 to outer location 244. This movement of laser beam 233 occurs as part of controller 214 controlling laser beam system 230 to perform scan 280 of search area 204 with laser beam 233.

The location of beam spot 270 changes over time as laser beam system 230 moves laser beam 233 along path 241 over time to perform a scan of search area 204. In this example, central location 240 is the location of beam spot 270 at the beginning of scan 280 and outer location 244 is the location of beam spot 270 at the end of scan 280.

In this example, beam spot 270 for laser beam 233 moves over time along path 241 within search area 204. Beam spot 270 is an area covered by laser beam 233. In this example, beam spot 270 is circular and has a size that can be adjusted. By moving laser beam 233 from location to location, beam spot 270 also moves from location to location in search area 204 along path 241.

Search area 204 is an area in which satellite 207 is expected to be located. In this example, search area 204 can be the same or can include an uncertainty area in which the satellite is expected to be located. The search area can be the uncertainty area in some examples.

In this illustrative example, central location 240 is selected as the location having the maximum probability that satellite 207 will be present. In one example, this location can be determined from the center of a gaussian distribution. The maximum of an uncertainty area is used as central location 240 from which path 241 starts.

In this example, outer location 244 in search area 204 is the last location in path 241 and can be along the perimeter of search area 204.

In this illustrative example, path 241 can take a number of different forms. In this example, path 241 can be selected from at least one of continuous path 242 or spiral path 243.

Path 241 is continuous path 242 when beam spot 270 moves to adjacent locations without gaps between the locations in path 241. Spiral path 245 begins at central location 240 and extends outward in a continuously curving trajectory to reach outer location 244. As spiral path 245 spirals outwards, each successive spiral is larger than the previous spiral.

Further in this example, controller 214 controls the laser beam system 230 to adjust a number of scan parameters 250 during movement of laser beam 233 on path 241. In this illustrative example, the number of scan parameters 250 can be adjusted to increase the likelihood that laser beam 233 hits satellite 207 in search area 204. The number of scan parameters 250 can be selected from at least one of scan speed 252, overlap 253 between spirals in a spiral path, beam divergence 254, or other suitable scan parameters.

In this illustrative example, controller 214 can perform a number of operations in response to locating satellite 207. For example, controller 214 can establish communications with satellite 207 in response to receiving a confirmation that satellite 207 has received laser beam 233.

In controlling the movement of laser beam 233 on path 241, controller 214 can control laser beam system 232 to move laser beam 233 on path 241 from central location 240 to outer location 244 with continuous movement 260. In this example, path 241 is a continuous path with continuous movement. In other words, laser beam 233 does not pause or wait at one location before moving to another location.

Thus, illustrative examples provide a method, apparatus, system, and computer program product for pointing an electromagnetic beam such as a laser beam to detect an object such as a satellite. In one illustrative example, a method points a laser beam. The laser beam is directed at a central location in a search area in which a satellite is expected to be located. The laser beam is moved in a path from the central location to an outer location. A number of scan parameters is adjusted during movement of the laser beam on the path. The adjustment of one or more of the scan parameters enables performing the scan to locate an object in the search area more quickly as compared to currently used techniques.

The illustration of search environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

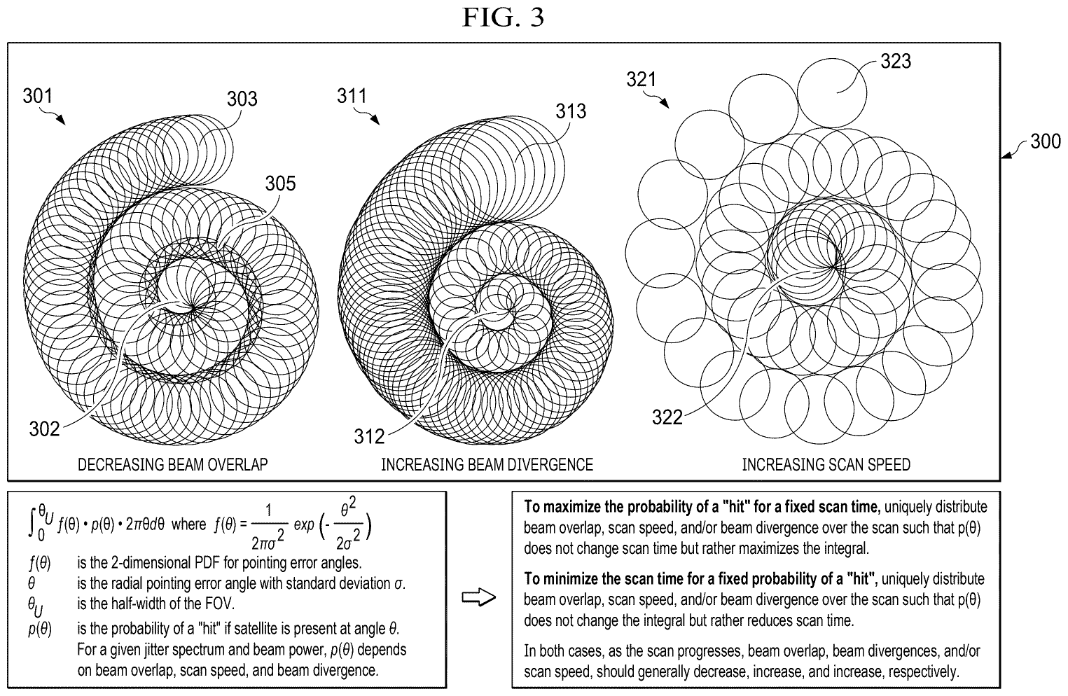

With reference next to FIG. 3, an illustration of a continuous spiral scan system is depicted in accordance with an illustrative environment. In this illustrative example, spiral scans 300 are continuous spiral scans that have continuous paths. In this example, the different spiral scans depicted have scan parameters. The scan parameters are examples of the number of scan parameters 248 in FIG. 2.

For example, spiral scan 301 is an example of decreasing beam overlap. As depicted, spiral scan 301 is comprised of locations for a beam spot in which each location is the location of the beam spot as the beam spot moves along a spiral path over time. The beam spot is represented by the circles for the locations and the beam spot moves in performing spiral scan 301. The center of each circle is the location at which the laser beam is pointed in this example.

The laser beam is pointed at a location. The diameter of each beam spot is dependent on the beam divergence and how far the beam has propagated. In spiral scan 301 the divergence is fixed. Divergence is the angle at which a laser beam spreads as the laser beam propagates.

With this example, the beam spot size is dependent on the distance of the location from the laser source. For example, a laser beam directed at an object at a location that is a first distance away from a laser source will have a first beam spot size. The laser beam directed at an object at a second location that is a second distance from the laser source will have a larger diameter if that second distance is greater than the first distance.

In this illustrative example, the beam spot for spiral scan 301 has the same diameter because the beam spot moves in a spiral path in an area where all of the locations are the same distance away from the laser beam source.

These locations are represented by circles. These locations are in a search area for spiral scan 301.

In this example, spiral scan 301 starts from central location 302 and moves from location to location on the spiral path to outer location 303. The direction of motion is in the direction from central location 302 to outer location 303. These locations from central location 302 to outer location 303 illustrate the spiral path for spiral scan 301. In this example, central location 302 is the innermost circle and outer location 303 is the outermost circle in spiral scan 301.

In this example, overlap 305 is present between the locations in spiral scan 301. Overlap 305 is the overlap between locations in adjacent portions of the spiral path for the locations from central location 302 to outer location 303.

For example, an overlap between two locations in spiral scan 301 can be the overlap between a first location on the spiral path and a second location that is perpendicular to the direction of motion of the laser beam on the spiral path.

In this example, the amount of overlap 305 decreases as the beam spot moves from central location 322 to outer location 323 along the spiral path. The amount of overlap 305 is greatest at central location 322 and the amount of overlap 305 is the least at outer location 323.

Next, spiral scan 311 is an example of increasing beam divergence. In this example, spiral scan 311 is comprised of locations for a beam spot in which each location is the location of the beam spot as the beam spot moves along a spiral path with a direction of motion starting at central location 312 and ending at outer location 313.

This scan shows an increasing divergence as the scan progresses from central location 312 to outer location 313. In this example, divergence of a laser beam can be from the laser beam source by changing the optical configuration of the laser beam source. This change in optical configuration can change the angle at which the laser beam diverges.

The divergence is the size of the beam spot in this example. The size of the beam spot is the size of the circles representing the locations for the beam spot in spiral scan 311. For example, central location 312 has a smaller divergence as compared to outer location 313.

Spiral scan 321 is an example of increasing scan speed. As depicted, spiral scan 321 is comprised of locations for a beam spot in which each location is the location of the beam spot as the beam spot moves along a spiral path with a direction of motion starting at central location 322 and ending at outer location 323. These locations are represented by circles with central location 302 being the innermost circle and outer location 303 being the outermost circle in spiral scan 301.

In this example, the speed of spiral scan 321 increases as the beam spot moves along a spiral path from central location 322 to outer location 323. The increasing speed is depicted by the distance between locations along the spiral path. As depicted, the distance between locations along the spiral path increases indicating an increase in scan speed.

With spiral scans 300, parameters such as overlap, divergence, and scan speed can be changed when a continuous scan is being performed as depicted in this figure.

The total overlap can be distributed to provide greater amounts of overlap in some parts of the path as compared to other parts of the path with the total overlap being the same as the path in which the amount of overlap does not change.

For example, the error in two-dimensional probability density function for pointing error angles is as follows:

$${\int }_{0}^{{θ}_{U}} f ( θ ) \cdot p ( θ ) \cdot 2 πθ d θ where = \frac{1}{2 π {σ}^{2}} exp ( - \frac{{θ}^{2}}{2 {σ}^{2}} )$$

where θ_{U} is the half-width of the field of view (FOV) and p(θ) is the probability of a “hit” if a satellite is present at angle θ. For a given jitter spectrum and beam power, p(θ) depends on beam overlap, scan speed, and beam divergence.

To maximize the probability of a “hit” for a fixed scan time, a number of scan parameters can be selected to at least one of uniquely distribute beam overlap, scan speed, or beam divergence over the scan such that p(θ) does not change scan time but rather maximizes the integral.

To minimize the scan time for a fixed probability of a “hit”, a number of scan parameters can be selected to at least one of uniquely distribute beam overlap, scan speed, and/or beam divergence over the scan such that p(θ) does not change the integral but rather reduces scan time.

In both cases, as the scan progresses, scan parameters such as at least one of beam overlap, scan speed, or beam divergence can be selected to at least one of decrease or increase.

The illustration of spiral scans 300 in FIG. 3 is presented as an example of one manner in which spiral scans can be implemented. This example is not meant to limit the manner in which other spiral scans can be implemented and what scan parameters can be changed in other examples. Further, although a single parameter such as overlap in spiral scan 301, divergence in spiral scan 311, scan speed in spiral scan 321 is changed, multiple scan parameters can change during the movement of the laser beam in other examples.

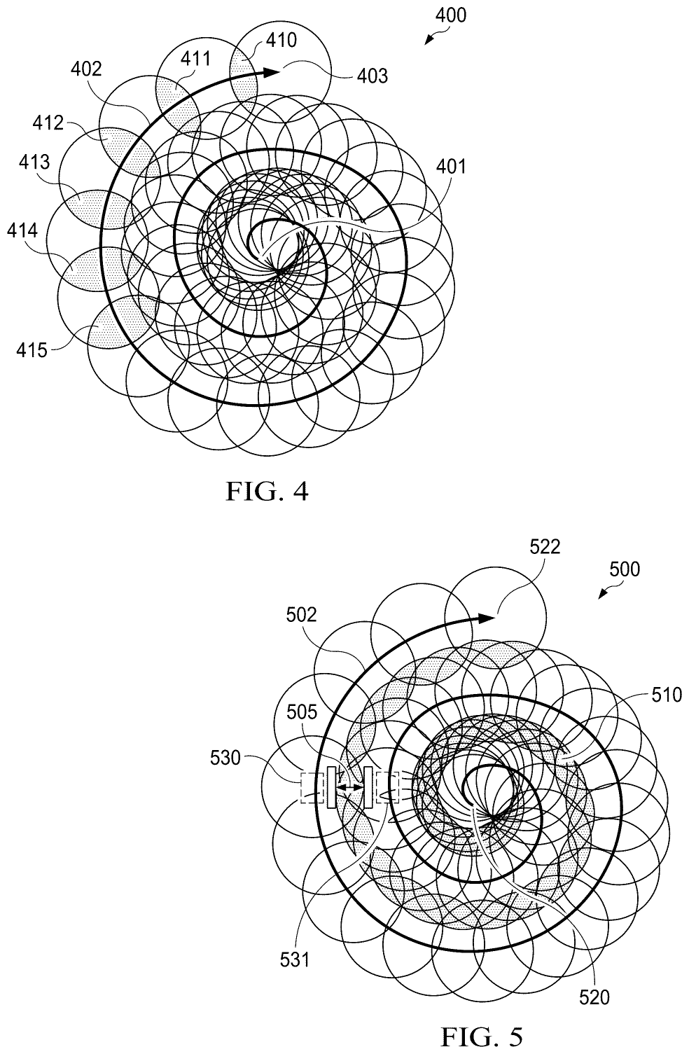

Turning next to FIG. 4, an illustration of scan speed for a spiral scan is depicted in accordance with an illustrative embodiment. In this example, spiral scan 400 is depicted in which each circle represents a location for a beam spot at a particular point in time. In this example, path 402 represents a path with a direction of motion of the beam spot on a plane in space as the beam spot moves on path 402 in spiral scan 400 from central location 401 to outer location 403.

In this example, overlap is present between locations in the direction of path 402. In this example, instances in time are equally spaced, and the overlap between two adjacent circles indicates the scan speed as shown by the regions. For example, region 410, region 411, region 412, region 413, region 414, and region 415 are examples of regions of overlap that can be used to indicate the scan speed.

In these examples, the greater amount of overlap results in a larger region that indicates a slower scan speed than a lesser amount of overlap with a smaller region. For example, the beam is scanning faster in spiral scan 400 at the portion of the scan with region 410 as compared to the portion of the scan with region 415. This overlap can also be referred to as motion overlap which can illustrate scan speed as a function of location in spiral scan 400.

In FIG. 5, an illustration of an overlap is depicted in accordance with an illustrative embodiment. In this illustrative example, spiral scan 500 comprises circles that represent a location for a beam spot at a particular point in time. In this example, path 502 represents the direction of motion of the beam spot on a path with a direction of motion on a plane in space as the beam spot moves on path 502 for spiral scan 500.

As depicted, overlap 510 is present between the adjacent portions of path 502 in spiral scan 500. In this example, the scan begins at central location 520 and ends at outer location 522.

In this illustrative example, the overlap of beam spot locations between two adjacent portions of path 502 is an overlap between the locations in the adjacent portions of path 502. For example, portion 530 of path 502 is adjacent to portion 531 of path 502.

In this example, the overlap is between a first location and a second location that is perpendicular to the direction of motion. In this example, overlap 510 has width 505. This width is constant along path 502 in this example but can be changed for different portions of path 502 in other examples such that the overlap between locations of the beam spot changes during movement of the beam spot on path 502. This overlap can be referred to as a path overlap and can be used to increase the probability of detecting an object such as a satellite while minimizing the time to scan a search area. In these examples, the probability of detecting the satellite is dependent in part on overlap 510 of adjacent portions of path 502.

The illustration of motion overlap in FIG. 4 and path overlap in FIG. 5 are provided as examples and not meant to limit the manner in which other illustrative examples can be implemented. For example, other scans can have other lengths. Further, in other scans, divergence can be different for different portions of the path.

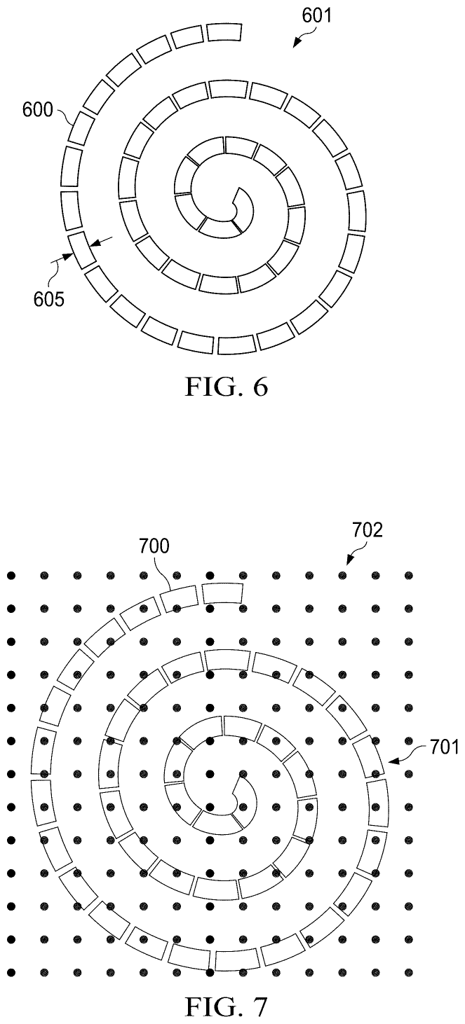

With reference to FIG. 6, an illustration of an overlap for a spiral scan is depicted in accordance with an illustrative embodiment. As depicted, overlap 600 represents the area where locations for a spot overlap as the laser beam is moved along a spiral path. In this example, overlap 600 is shown as being the same throughout a spiral scan. In this example, overlap 600 is divided into segments 601. In this example, the segments each have the same length. These segments are shown as having the same thickness, meaning that each segment has the same amount of overlap. In this example, overlap 600 has width 605.

In this illustrative example, the overlap can be selected to increase the ability to detect a jumper. In this example, a jumper is an object that is missed by a laser beam that is pointed to a location in which the object is located. The laser beam can miss the object because of beam vibrations. These beam vibrations can be caused by jitter. From the laser beam's frame of reference, the object appears to “jump” outside of the beam spot.

The overlap where the spot of the laser beam on the current portion of a path overlaps a prior portion of the path or overlaps a future portion of the path can increase the ability to detect a jumper.

The amount of overlap in different segments of the path can be selected such that the time needed to scan the entire path is the same as if the spiral path used the same amount of overlap for the entire path. In other words, different segments can have different amounts of overlap such that the total overlap present along the spiral path for the segments can be the same as the total overlap for a path in which the amount of overlap is the same along the spiral path.

Turning next to FIG. 7, an illustration of an overlap based on jumper distribution is depicted in accordance with an illustrative embodiment. In this illustrative example, overlap 700 is comprised of segments 701. Jumpers 702 are shown as dots.

A jumper can cause the laser beam to miss the intended location for generating backscatter light to make a measurement at the location. In other words, that measurement can be clear air turbulence. The location to which the jumper causes backscatter light may have an absence of clear air turbulence. As a result, jumpers can reduce the accuracy of measurements when scanning an area. A similar issue can occur if the scanning is being performed to identify objects such as insects in the area.

If most jumpers are located at the center of an area, the amount of overlap can be greater in those areas as compared to other areas. As a result, greater overlap is present for segments closer to the center with segments father away from the center having less overlap.

In this example, a uniform distribution of jumpers 702 are shown in this figure. With this distribution, segments 701 in overlap 700 can all have the same amount of overlap because the segments can detect jumpers 702 equally because of the uniform distribution based on the likelihood that the object of interest is at center 812.

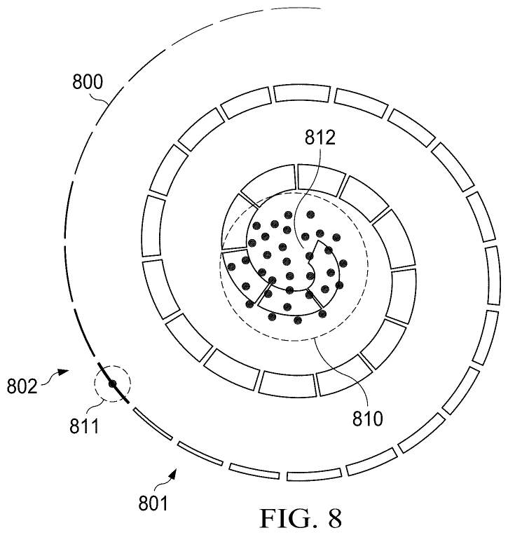

Next in FIG. 8, an illustration of an overlap based on a jumper distribution is depicted in accordance with an illustrative embodiment. In this example, overlap 800 is comprised of segments 801. In this example, jumpers 802 are present. With this example, most of jumpers 802 are located in region 810 with a single jumper being located in region 811.

With most of jumpers 802 located in center 812 of the spiral, the segments located near center 812 detect more jumpers. Thus, these segments have a high value. Likewise, only a single jumper is located in region 811. The segments located near the edge detect very few jumpers. These segments have a low value.

In this example, the object of interest has the highest probability of being at or near center 812. In other examples, the flight path passes through center 812.

As a result, the importance of making measurements to detect an object are more important at center 812 than at the end of the scan. The measurements may have a curve with a Gaussian shape. For example, the breadth of the Gaussian shape can be a standard deviation (STD) determined by the distance of the area being scanned in front of the aircraft. For example, the standard deviation at 30 meters is smaller than the standard deviation at 10 kilometers. Further, a cross wind can shift the center of the Gaussian curve towards the direction from which the wind originates.

The illustration of overlaps in FIGS. 6-8 have been provided as examples and are not meant to limit the manner in which other illustrative examples can be implemented. For example, segments can increase in overlap at least in portions of the path as compared to other portions. The selection of which segments have greater overlap can be based on the probability that jumpers are located in different portions of the path for the spiral scan.

Further, the illustrative examples depicted in FIGS. 3-8 can be applied to other types of electromagnetic beams in addition to or in place of laser beams. For example, these different examples can also be applied to a radio frequency beam, a microwave beam, or other electromagnetic beams.

Further, the illustrative examples depicted in FIGS. 3-8 can be applied to other types of electromagnetic beams in addition to or in place of laser beams. For example, these different examples can also be applied to a radio frequency beam, a microwave beam, or other electromagnetic beams.

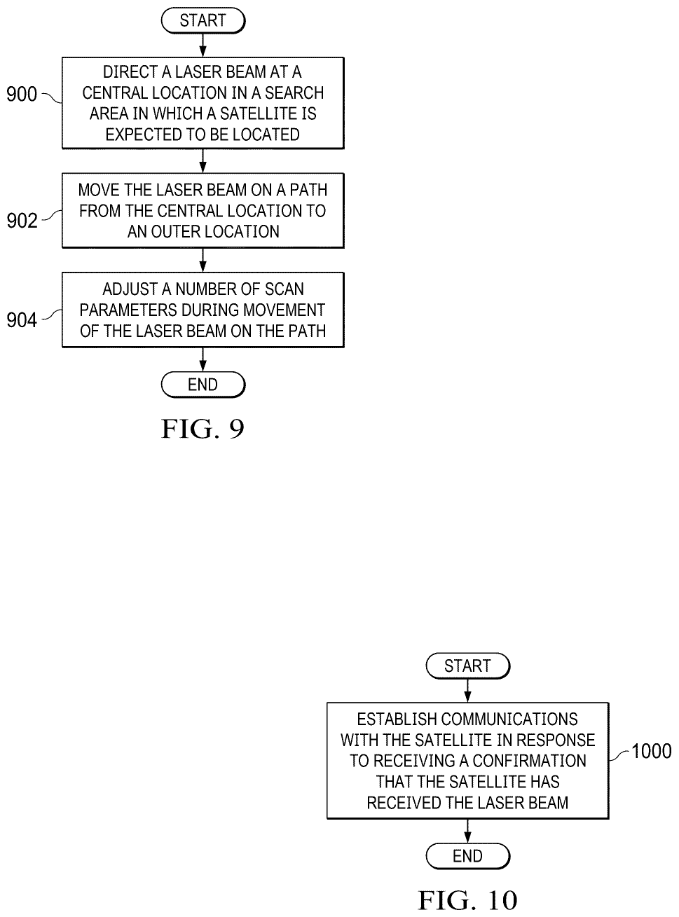

Turning next to FIG. 9, an illustration of a flowchart of a process for pointing a laser beam is depicted in accordance with an illustrative embodiment. The process in FIG. 9 can be implemented in hardware, software, or both. When implemented in software, the process can take the form of program instructions that are run by one of more processor units located in one or more hardware devices in one or more computer systems. For example, the process can be implemented in controller 214 in computer system 212 in FIG. 2.

The process begins by directing a laser beam at a central location in a search area in which a satellite is expected to be located (operation 900). The process moves the laser beam on a path from the central location to an outer location (operation 902).

The process adjusts a number of scan parameters during movement of the laser beam on the path (operation 904). The process terminates thereafter. In operation 904, the number of scan parameters can be selected from at least one of a scan speed, an overlap, a scan speed, a beam divergence, or other suitable parameter.

With reference now to FIG. 10, an illustration of a flowchart of a process for establishing communications is depicted in accordance with an illustrative embodiment. The process in this figure is an example of an additional operation that can be performed with the operations in FIG. 9.

The process establishes communications with the satellite in response to receiving a confirmation that the satellite has received the laser beam (operation 1000). The process terminates thereafter. In operation 1000, the movement of laser the laser beam can be halted because the process has located the satellite. The communications can be unidirectional or bidirectional and can be performed using the laser beam or another type of electromagnetic signal such as a microwave beam.

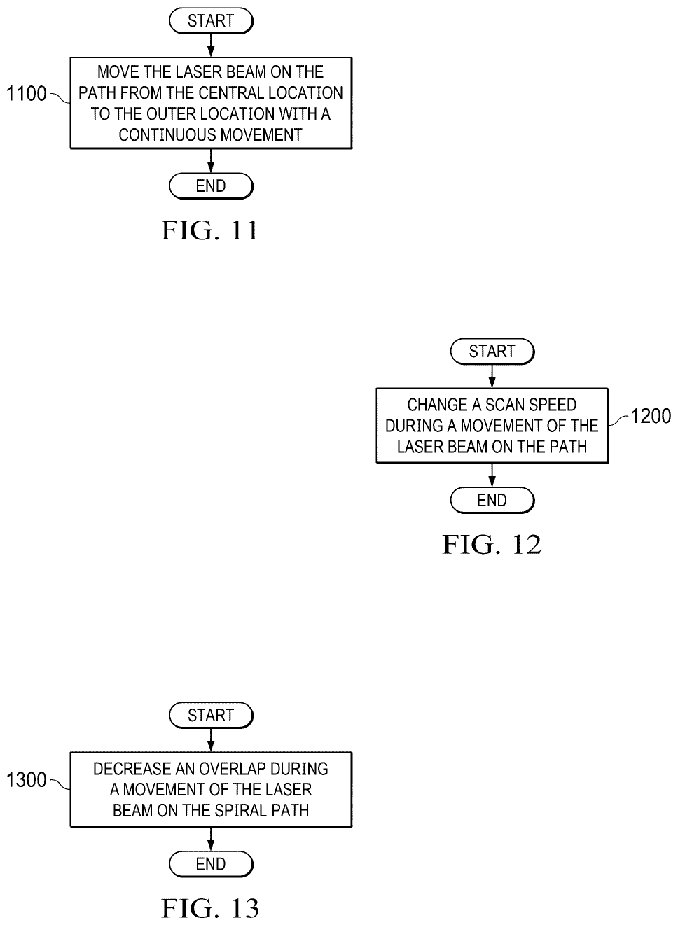

Turning to FIG. 11, an illustration of a flowchart of a process for moving a laser beam is depicted in accordance with an illustrative embodiment. The process in this figure is an example of an implementation for operation 902 in FIG. 9.

The process moves the laser beam on the path from the central location to the outer location with a continuous movement (operation 1100). The process terminates thereafter.

In FIG. 12, an illustration of a flowchart of a process for adjusting a number of scan parameters is depicted in accordance with an illustrative embodiment. The process in this flowchart is an example of an implementation for operation 904 in FIG. 9. This process can be performed when the laser beam is moved with a continuous movement.

The process changes a scan speed during a movement of the laser beam on the path (operation 1200). The process terminates thereafter. In this illustrative example, the scan speed can be changed by at least one of increasing or decreasing the scan speed.

With reference to FIG. 13, an illustration of a flowchart of a process for adjusting a number of scan parameters is depicted in accordance with an illustrative embodiment. The process in this flowchart is an example of an implementation for operation 904 in FIG. 9. This process can be performed when the laser beam is moved with a continuous movement. In this example, the path is a spiral path.

The process decreases an overlap during a movement of the laser beam on the spiral (1300). The process terminates thereafter.

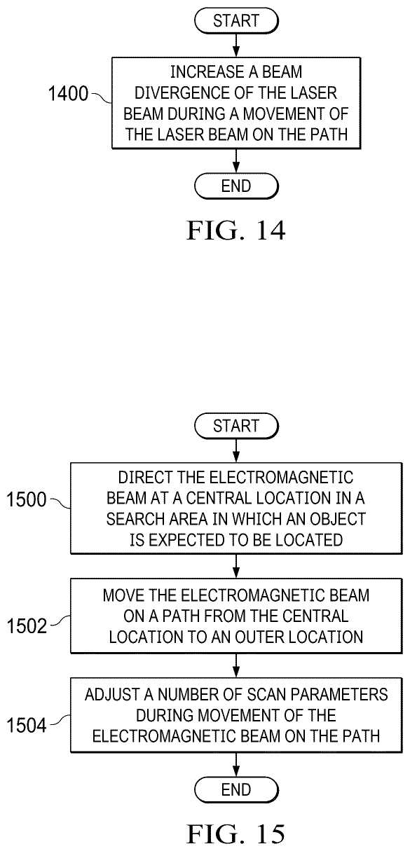

Next in FIG. 14, an illustration of a flowchart of a process for adjusting a number of scan parameters is depicted in accordance with an illustrative embodiment. The process in this flowchart is an example of an implementation for operation 904 in FIG. 9. This process can be performed when the laser beam is moved with a continuous movement.

The process increases a beam divergence of the laser beam during a movement of the laser beam on the path (operation 1400). The process terminates thereafter.

Turning next to FIG. 15, an illustration of a flowchart of a process for pointing an electromagnetic beam is depicted in accordance with an illustrative embodiment. The process in FIG. 15 can be implemented in hardware, software, or both. When implemented in software, the process can take the form of program instructions that are run by one of more processor units located in one or more hardware devices in one or more computer systems. For example, the process can be implemented in controller 214 in computer system 212 in FIG. 2.

The process directs the electromagnetic beam at a central location in a search area in which an object is expected to be located (operation 1500). In operation 1500, the object can be selected from a group comprising a platform, a stationary platform, a land-based structure, an aquatic-based structure, a space-based structure, an aircraft, a vehicle controlled by an artificial intelligence system, a commercial aircraft, a rotorcraft, a tilt-rotor aircraft, a tilt wing aircraft, a vertical takeoff and landing aircraft, an electrical vertical takeoff and landing vehicle, a personal air vehicle, an artificial intelligence controller air vehicle, a surface ship, a tank, a personnel carrier, a train, a spacecraft, a space station, a satellite, a submarine, an automobile, a power plant, a bridge, a dam, a house, a manufacturing facility, a building, and other suitable objects.

The process moves the electromagnetic beam on a path from the central location to an outer location (operation 1502). The process adjusts a number of scan parameters during movement of the electromagnetic beam on the path (operation 1504). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

Pointing the electromagnetic signal receiver to search for an electromagnetic signal source also takes more time than desired and is more challenging than desired.

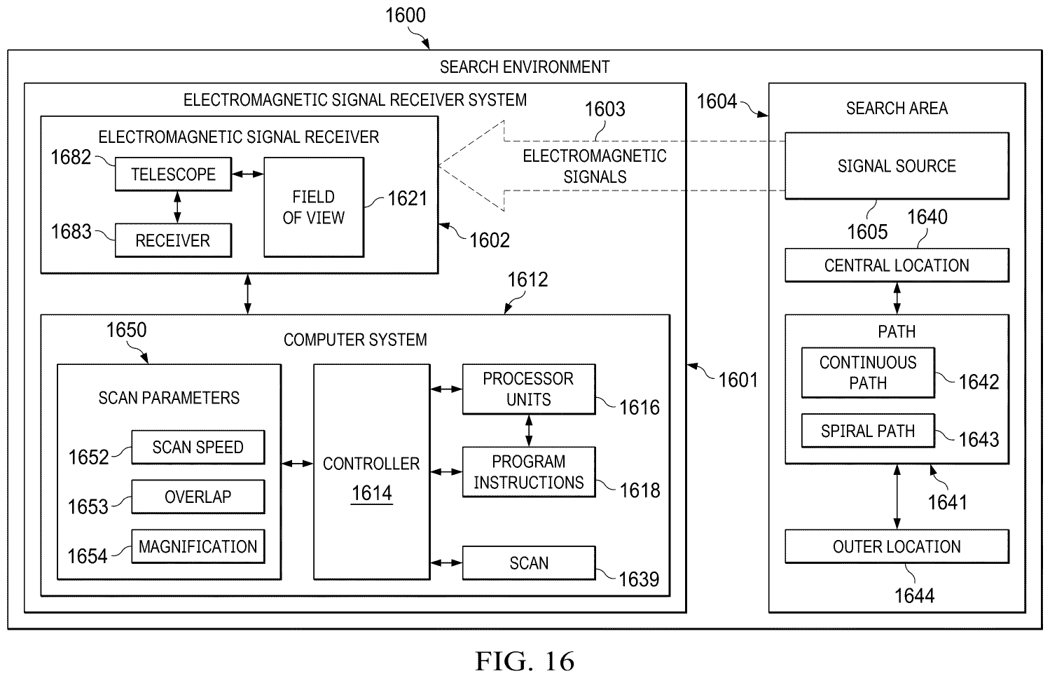

With reference now to FIG. 16, an illustration of a block diagram of a search environment is depicted in accordance with an illustrative embodiment. In this illustrative example, search environment 1600 includes components that can be implemented in hardware such as the hardware shown in satellite 120 and receiver 122 and telescope 123 in FIG. 1.

In the illustrative example, electromagnetic signal receiver system 1601 in search environment 1600 can be pointed to receive electromagnetic signals 1603 from signal source 1605. In this example, electromagnetic signal receiver system 1601 comprises electromagnetic signal receiver 1602 and controller 1614. In this example, controller 1614 is located in computer system 1612. As depicted, computer system 1612 is part of electromagnetic signal receiver system 1601 in this example.

In this illustrative example, signal source 1605 generates electromagnetic signals 1603. Electromagnetic signals 1603 can take a number of different forms. For example, electromagnetic signals 1603 can be in a beam, collimated beam, omnidirectional signals, directional signals, or other types of radiation patterns or forms. Electromagnetic signals 1603 can be selected from at least one of a laser beam, a radio frequency beam, a microwave beam, microwave signals, infrared signals, visible light signals, ultraviolet light signals, or other types of electromagnetic signals 1603.

Signal source 1605 can take a number of different forms. For example, signal source 1605 can be selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a spacecraft, a space station, a satellite, a submarine, an automobile, a power plant, a bridge, a dam, a house, a manufacturing facility, and a building.

Electromagnetic signal receiver 1602 is a physical hardware system that can receive electromagnetic signals 1603. Electromagnetic signal receiver 1602 has field of view (FOV) 1621. In this illustrative example, hardware such as an antenna, radio receiver, photo detector, or other device that can detect electromagnetic signals 1603 that are in field of view 1621. This hardware is unable to detect or use electromagnetic signals 1603 outside the field of view 1621.

The hardware can include receiver 1683. Receiver 1683 can be implemented using a receiver such as a photodetector, a photodiode system, a phase array antenna, focal plane array (FPA), cell (QC), fiber-optic nutator, or other suitable types of hardware.

In another illustrative example, electromagnetic signal receiver 1602 can also include telescope 1682. Telescope 1682 is a hardware component collecting incoming electromagnetic signals onto a detector in receiver 1683.

In this illustrative example, field of view (FOV) 1621 is the view that electromagnetic signal receiver 1602 has to see or receive electromagnetic signals 1603. Field of view 1621 may be described as the angular range within which electromagnetic signal receiver 1602 can detect or receive electromagnetic signals 1603. In this example, field of view 1621 can be defined by telescope 1682.

In this depicted example, field of view 1621 can also be described as the instantaneous angle subtended by the scanning system that exceeds the detection threshold (e.g., the divergence angle of the laser beam (above threshold) for a laser-scanning system or the sensor field of view for a receiving sensor).

In some illustrative examples, the size of field of view 1621 can be controlled. Field of view 1621 should have a size that enables detecting electromagnetic signals 1603. For example, the time for scan 1639 to locate signal source 1605 is faster than current techniques such as those that use a continuous scan, a segment scan, or a raster scan. However, actually detecting electromagnetic signals 1603 may be difficult with electromagnetic signals 1603 being too weak for detection with the size of field of view 1621. For example, the aperture or coping defining the field of view for a receiver may pick up signals from other sources for noises in addition to the signals from the desired source. As a result, the receiver may struggle to identify and isolate electromagnetic signals 1603 from the surrounding noise. As a result, reducing or narrowing field of view 1621 can be performed to reduce issues with noise. In other words, the size of field of view 1621 can be adjusted to increase the signal-to-noise ratio.

In another example, the scan time becomes slower as field of view 1621 is decreased. At some point, field of view 1621 may be able to easily detect electromagnetic signals 1603. However, the amount of scan time may be much slower than desired and may be slower than current techniques.

The size of field of view 1621 can be selected such that electromagnetic signals 1603 can be just barely detectable. In other words, these electromagnetic signals can be detected over noise that may be present. With this size for field of view 1621, scan 1639 can be performed within an amount of time that is less than using current techniques.

Controller 1614 can be implemented in the same manner as controller 214 in FIG. 2 in which program instructions 1618 can be used to implement controller 1614 that are executed by a number of processor units 316 in computer system 1612. Program instructions 1618, the number of processor units 1616, and computer system 1612 can be implemented in a manner similar to program instructions 218, processor units 216, and the computer system 212 in FIG. 2.

Controller 1614 is configured to control the operation of electromagnetic signal receiver 1602. In this illustrative example, controller 1614 controls electromagnetic signal receiver 1602 to move field of view 1621 of electromagnetic signal receiver 1602 to central location 1640 in search area 1604 in which signal source 1605 is expected to be located. Controller 214 also controls the electromagnetic signal receiver 1602 to move field of view 1621 on path 1641 from central location 1640 to outer location 1644. This movement of field of view 1621 occurs as part of controller 214 controlling electromagnetic signal receiver 1602 to perform scan 1639 of search area 204 with field of view 1621.

In this illustrative example, central location 1640 is selected as the location having the maximum probability that signal source 1605 will be present. In one example, this location can be determined from the center of a gaussian distribution. The maximum of an uncertainty area is used as central location 1640 from which path 1641 starts.

In this example, outer location 1644 in search area 1604 is the last location in path 1641 and can be along the perimeter of search area 1604. In this illustrative example, path 1641 can take a number of different forms. In this example, path 1641 can be selected from at least one of continuous path 1642 or spiral path 1643.

Path 1641 is continuous path 1642 when field of view 1621 moves to adjacent locations without gaps between the locations in path 1641. Spiral path 1643 begins at central location 1640 and extends outward in a continuously curving trajectory to reach outer location 1644. As spiral path 1643 spirals outwards, each successive spiral is larger than the previous spiral.

Further in this example, controller 1614 controls the electromagnetic receiver beam system 1601 to adjust a number of scan parameters 1650 during movement of laser beam 233 on path 241. In this illustrative example, the number of scan parameters 250 can be adjusted to increase the likelihood that field of view 1621 receives electromagnetic signals 1603 from electromagnetic signal source 1605. The number of scan parameters 1650 can be selected from at least one of scan speed 1652, overlap 1653 between spirals in a spiral path, magnification 1654, or other suitable scan parameters.

When telescope 1682 is used to find signal source 1605 in an uncertainty area of space, the probability of the location of the object is greatest at the center of the uncertainty area and decreases moving away from this center as described by a two dimensional Gaussian curve. In this example, the center of the uncertainty area is central location 1640.

For a given uncertainty area, field of view 1621 of telescope 1682 is scanned by beginning at a central location 1640 located at the center of the uncertainty area and moves further away from central location 1640 until field of view 1621 reaches the end of its spiral path at outer location 1644, which is located on the perimeter of the uncertainty area, which is search area 1604 in this example.

If signal source 1605 exists at a particular location in the sky, the probability of finding that signal source 1605 can be improved by performing a number of adjusting scan parameters 1650 during scan 1639 along path 1641. For example, magnification 1654 is the magnification of the telescope at a particular location along path 1641. Magnification 1654 can be increased by decreasing field of view 1621.

Increasing magnification 1654 can be accomplished by decreasing field of view 1621, which results in more spirals in scan 1639, which results in a greater scan time. The consequence of increasing overlap 1653 of field of view 1621 is more spirals in the scan, which results in a greater scan time.

For example, the scan time for performing scan 1639 using path 1641 from central location 1640 to outer location 1644 in search area 1604 is a selected amount of time when scan parameters 1650 are fixed. A number of the scan parameters can be adjusted during scan 1639 using path 1641 without increasing the selected amount of time.

In other words, a number of scan parameters 1650 can be adjusted in a manner that the amount of scan time remains the same as compared to not adjusting scan parameters 1650. These adjustments to a number of scan parameters 1650 are selected to increase the likelihood of detecting electromagnetic signals 1603 from signal source 1605.

For example, magnification 1654 can be adjusted to different amounts along path 1641. This adjustment can be made to increase the likelihood of detecting signal source 1605 while not increasing the scan time to perform scan 1639. In this example, the probability of the location of signal source 1605 is greatest at the central location 1640 in search area 1604, and scan time is limited to perform scan 1639 with a desired amount of time to meet requirements such as a service level agreement (SLA). In this case, magnification is decreased as scan 1639 progresses along path 1641, having the highest magnification at central location 1640 (i.e., most likely to be detected here) and the lowest magnification at outer location 1644 (i.e., least likely to be detected here).

Scan speed 1652 is an angular scan speed of field of view 1621 and is another scan parameter that can be adjusted during performance of scan 1639 along path 1641. In this example, the probability of the location of signal source 1605 is greatest at the central location 1640, and scan time is limited. Scan speed 1652 and the increased as field of view 1621 moves along path 1641. As the scan speed decreases, the probability of detecting signal source 1605 increases when moving field of view 1621 along path 1641.

With this example, scan speed 1652 is the slowest at central location 1640 and fastest at outer location 1644. Central location 1640 is the location in which signal source 1605 is most likely to be detected, and outer location 1644 is a location in which signal source 1605 is least likely to be detected.

Overlap 1653 is an overlap of field of view 1621 occurring at the adjacent portions of path 1641. In this example, the probability of the location of signal source 1605 is greatest at central location 1640 in search area 1604, and scan time is limited. Overlap 1653 between adjacent sections of the spiral path for field of view 1621 can be decreased as scan 1639 progresses along path 1641. The greatest overlap at central location 1640 (i.e., most likely to be detected here), and the least overlap is at outer location 1644 (i.e., least likely to be detected here).

Thus, the number of scan parameters 1650 can be adjusted during scan 1639 of search area 1604 along path 1641 in a manner that increases the likelihood of detecting electromagnetic signals 1603 from signal source 1605 without increasing the scan time needed to scan search area 1604.

In the illustrative examples, adjusting one or more of scan parameters 1650 can increase the likelihood of detecting electromagnetic signals 1603 from signal source 1605. This increased likelihood of detection can occur without increasing the amount of time.

In this illustrative example, controller 1614 can perform a number of operations in response to receiving electromagnetic signals 1603 from signal source 1605 in search area 1604. Controller 1614 can halt moving field of view 1621 in response to detecting electromagnetic signals 1603 from signal source 1605. In this example, controller 1614 can detect the electromagnetic signals 1603 from signal source 1605 in response to detecting selected electromagnetic signals that are greater than a noise level threshold in field of view 1621. The noise level threshold can be used to distinguish electromagnetic signals 1603 that are from signal source 1605 from electromagnetic signals 1603 that are noise.

In this example, controller 1614 can establish communications with signal source 1605 in response to receiving a confirmation that satellite 207 has received laser beam 233. These communications can be one of unidirectional communications and bidirectional communications. In other examples, controller 1614 can log or save the location of signal source 1605. With this example, controller 1614 can continue scan 1639 on path 1641 to detect another signal source or start a new scan in the same search area or a new search area.

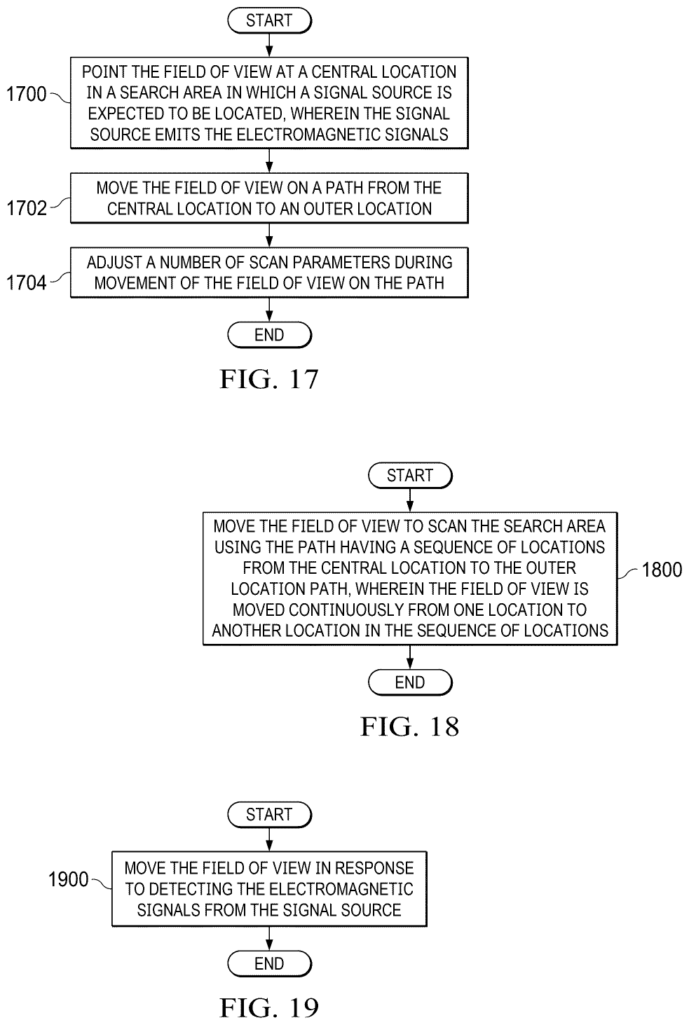

With reference next to FIG. 17, an illustration of a flowchart of a process for receiving electromagnetic signals is depicted in accordance with an illustrative embodiment. The process in FIG. 17 can be implemented in hardware, software, or both. When implemented in software, the process can take the form of program instructions that are run by one of more processor units located in one or more hardware devices in one or more computer systems. This process can be implemented to identify locations for pointing an electromagnetic beam emitted from magnetic beam transmission system from and for pointing a field of view or an electromagnetic signal receiver. For example, the process can be implemented in controller 1614 in controller 1614 in computer system 1612 in electromagnetic signal receiver system 1601 in FIG. 16.

The process begins by pointing the field of view at a central location in a search area in which a signal source is expected to be located, wherein the signal source emits the electromagnetic signals (operation 1700). In operation 1700, the electromagnetic signals can be selected from at least one of a laser beam, a radio frequency beam, a microwave beam, microwave signals, infrared signals, and ultraviolet light signals.

The process moves the field of view on a path from the central location to an outer location (operation 1702). In one illustrative example, the movement of the field of view is in a form of a spiral scan. In operation 1702, the path can be selected from at least one of a continuous path or a spiral path.

The process adjusts a number of scan parameters during movement of the field of view on the path (operation 1704).

Turning to FIG. 18, an illustration of a flowchart of a process for moving a field of view is depicted in accordance with an illustrative embodiment. The process in this flowchart is an example of an implementation for operation 1702 in FIG. 17.

The process moves the field of view to scan the search area using the path having a sequence of locations from the central location to the outer location path, wherein the field of view is moved continuously from one location to another location in the sequence of locations (operation 1800). The process terminates thereafter.

Next in FIG. 19, an illustration of a flowchart of a process for halting movement of a field of view is depicted in accordance with an illustrative embodiment. The process in this flowchart is an example of an additional operation that can be performed with the operations in FIG. 17.

The process moves the field of view in response to detecting the electromagnetic signals from the signal source (operation 1900). The process terminates thereafter.

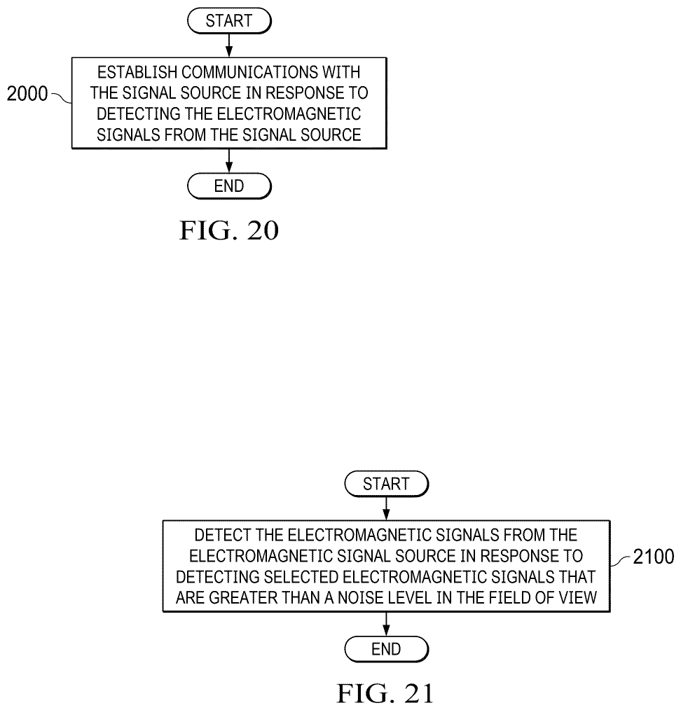

With reference now to FIG. 20, an illustration of a flowchart of a process for establishing communications is depicted in accordance with an illustrative embodiment. The process in this flowchart is an example of an additional operation that can be performed with the operations in FIG. 17 and FIG. 19.

The process establishes communications with the signal source in response to detecting the electromagnetic signals from the signal source (operation 2000). The process terminates thereafter. In this example, indications can be established in a number of different ways. For example, an acknowledgment can be returned to the signal source. In another example, the communications can be established by processing electromagnetic signals 1603 without needing to send an acknowledgment.

In FIG. 21, an illustration of a flowchart of a process for detecting electromagnetic signals is depicted in accordance with an illustrative embodiment. The process in FIG. 21 is an example of an additional operation that can be performed with the operations in FIG. 17.

The process detects the electromagnetic signals from the electromagnetic signal source in response to detecting selected electromagnetic signals that are greater than a noise level threshold in the field of view (operation 2100). The process terminates thereafter.

Thus, these examples provide a method, apparatus, system, and computer program product for receiving electromagnetic signals. In one illustrative example, an electromagnetic signal receiver system comprises an electromagnetic signal receiver and a controller. The electromagnetic signal receiver has a field of view in which electromagnetic signals are received. The controller is configured to control the electromagnetic signal receiver to point the field of view at a central location in a search area in which a signal source is expected to be located. The controller is configured to control the electromagnetic signal receiver to move the field of view on a path from the central location to an outer location. The controller is configured to control the electromagnetic signal receiver to adjust a number of scan parameters during movement of the field of view on the path.

In another illustrative example, a method receives electromagnetic signals. The field of view is pointed at a central location in a search area in which a signal source is expected to be located, wherein the signal source emits the electromagnetic signals. The field of view is moved on a path from the central location to an outer location. A number of scan parameters is adjusted during movement of the field of view on the path.

Some features of the illustrative examples for pointing an electromagnetic signal receiver are described in the following clauses. These clauses are examples of features and are not intended to limit other illustrative examples.

### Clause 1

An electromagnetic signal receiver system comprising:
an electromagnetic signal receiver having a field of view in which electromagnetic signals are received; and
a controller configured to control the electromagnetic signal receiver to:
point the field of view at a central location in a search area in which a signal source is expected to be located;
move the field of view on a path from the central location to an outer location; and
adjust a number of scan parameters during movement of the field of view on the path.

### Clause 2

The electromagnetic signal receiver system of clause 1, wherein a movement of the field of view is in a form of a spiral scan.

### Clause 4

The electromagnetic signal receiver system of clause 1, wherein in continuing to move the field of view, the controller is configured to:
move the field of view to scan the search area using the path having a sequence of locations from the central location to the outer location path, wherein the field of view is moved continuously from one location to another location in the sequence of locations.

### Clause 5

The electromagnetic signal receiver system of clause 1, wherein the controller is configured to control the electromagnetic signal receiver system to:
halt moving the field of view in response to detecting the electromagnetic signals from the signal source.

### Clause 6

The electromagnetic signal receiver system of clause 5, wherein the controller is configured to:
establish communications with the signal source in response to detecting the electromagnetic signals from the signal source.

### Clause 7

The electromagnetic signal receiver system of clause 5, wherein the path is selected from at least one of a continuous path or spiral path.

### Clause 8

The electromagnetic signal receiver system of clause 7, wherein the communications are selected from one of unidirectional communications and bidirectional communications.

### Clause 9

The electromagnetic signal receiver system of clause 1, wherein the controller is configured to:
detect the electromagnetic signals from the signal source in response to detecting selected electromagnetic signals that are greater than a noise level threshold in the field of view.

### Clause 10

The electromagnetic signal receiver system of clause 1, wherein the electromagnetic signal receiver is a receiver and a telescope.

### Clause 11

The electromagnetic signal receiver system of clause 1, wherein the electromagnetic signals are selected from at least one of a laser beam, a radio frequency beam, a microwave beam, microwave signals, infrared signals, visible light signals, or ultraviolet light signals.

### Clause 12

A method for receiving electromagnetic signals comprising:
pointing the field of view at a central location in a search area in which a signal source is expected to be located, wherein the signal source emits the electromagnetic signals;
moving the field of view on a path from the central location to an outer location; and
adjusting a number of scan parameters during movement of the field of view on the path.

### Clause 13

The method of clause 12, wherein a movement of the field of view is in a form of a spiral scan.

### Clause 15

The method of claim 12, wherein moving the field of view comprises:
move the field of view to scan the search area using the path having a sequence of locations from the central location to the outer location path, wherein the field of view is moved continuously from one location to another location in the sequence of locations.

### Clause 16

The method of clause 12 further comprising:
halting moving the field of view in response to detecting the electromagnetic signals from the signal source.

### Clause 17

The method of clause 16 further comprising:
establishing communications with the signal source in response to detecting the electromagnetic signals from the signal source.

### Clause 18

The method of clause 12, wherein the path is selected from at least one of a continuous path or and a spiral path.

### Clause 19

The method of clause 14 further comprising:
detecting the electromagnetic signals from the electromagnetic signal source in response to detecting selected electromagnetic signals that are greater than a noise level threshold in the field of view.

### Clause 20

The method of clause 12, wherein the electromagnetic signals are selected from at least one of a laser beam, a radio frequency beam, a microwave beam, microwave signals, infrared signals, and ultraviolet light signals.

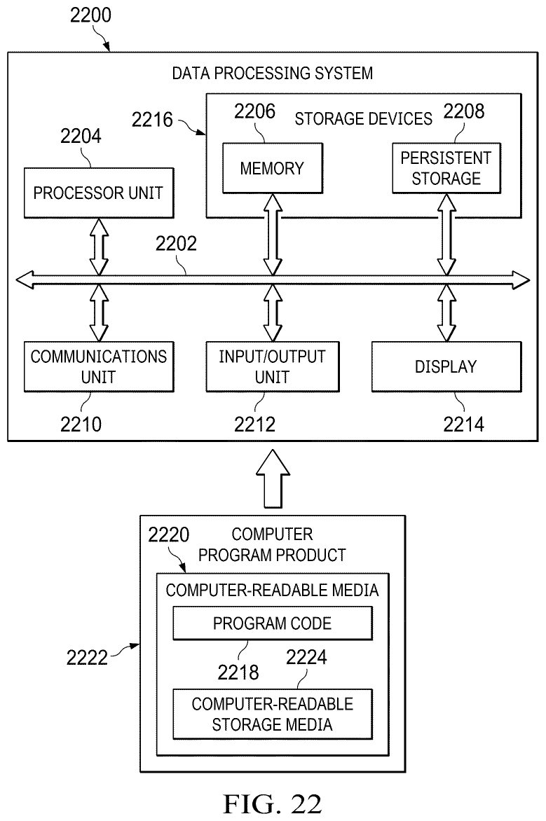

Turning now to FIG. 22, a block diagram of a data processing system is depicted in accordance with an illustrative embodiment. Data processing system 2200 can be used to implement computer system 212 in FIG. 2. In this illustrative example, data processing system 2200 includes communications framework 2202, which provides communications between processor unit 2204, memory 2206, persistent storage 2208, communications unit 2210, input/output (I/O) unit 2212, and display 2214. In this example, communications framework 2202 takes the form of a bus system.

Processor unit 2204 serves to execute instructions for software that can be loaded into memory 2206. Processor unit 2204 includes one or more processors. For example, processor unit 2204 can be selected from at least one of a multicore processor, a central processing unit (CPU), a graphics processing unit (GPU), a physics processing unit (PPU), a digital signal processor (DSP), a network processor, or some other suitable type of processor. Further, processor unit 2204 can be implemented using one or more heterogeneous processor systems in which a main processor is present with secondary processors on a single chip. As another illustrative example, processor unit 2204 can be a symmetric multi-processor system containing multiple processors of the same type on a single chip.

Memory 2206 and persistent storage 2208 are examples of storage devices 2216. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 2216 may also be referred to as computer-readable storage devices in these illustrative examples. Memory 2206, in these examples, can be, for example, a random-access memory or any other suitable volatile or non-volatile storage device. Persistent storage 2208 may take various forms, depending on the particular implementation.

For example, persistent storage 2208 may contain one or more components or devices. For example, persistent storage 2208 can be a hard drive, a solid-state drive (SSD), a flash memory, a rewritable optical disk, a rewritable magnetic tape, or some combination of the above. The media used by persistent storage 2208 also can be removable. For example, a removable hard drive can be used for persistent storage 2208.

Communications unit 2210, in these illustrative examples, provides for communications with other data processing systems or devices. In these illustrative examples, communications unit 2210 is a network interface card.

Input/output unit 2212 allows for input and output of data with other devices that can be connected to data processing system 2200. For example, input/output unit 2212 may provide a connection for user input through at least one of a keyboard, a mouse, or some other suitable input device. Further, input/output unit 2212 may send output to a printer. Display 2214 provides a mechanism to display information to a user.

Instructions for at least one of the operating system, applications, or programs can be located in storage devices 2216, which are in communication with processor unit 2204 through communications framework 2202. The processes of the different embodiments can be performed by processor unit 2204 using computer-implemented instructions, which may be located in a memory, such as memory 2206.

These instructions are referred to as program instructions, computer-usable program instructions, or computer-readable program instructions that can be read and executed by a processor in processor unit 2204. The program instructions in the different embodiments can be embodied on different physical or computer-readable storage media, such as memory 2206 or persistent storage 2208.

Program instructions 2218 are located in a functional form on computer-readable media 2220 that is selectively removable and can be loaded onto or transferred to data processing system 2200 for execution by processor unit 2204. Program instructions 2218 and computer-readable media 2220 form computer program product 2222 in these illustrative examples. In the illustrative example, computer-readable media 2220 is computer-readable storage media 2224.

Computer-readable storage media 2224 is a physical or tangible storage device used to store program instructions 2218 rather than a medium that propagates or transmits program instructions 2218. Computer-readable storage media 2224 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits/lands formed in a major surface of a disc, or any suitable combination thereof.

Computer readable storage media 2224, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation or garbage collection. However, these operations do not render the storage device as transitory because the data is not transitory while the data is stored in the storage device.

Alternatively, program instructions 2218 can be transferred to data processing system 2200 using a computer-readable signal media. The computer-readable signal media are signals and can be, for example, a propagated data signal containing program instructions 2218. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 2220” can be singular or plural. For example, program instructions 2218 can be located in computer-readable media 2220 in the form of a single storage device or system. In another example, program instructions 2218 can be located in computer-readable media 2220 that is distributed in multiple data processing systems. In other words, some instructions in program instructions 2218 can be located in one data processing system while other instructions in program instructions 2218 can be located in another data processing system. For example, a portion of program instructions 2218 can be located in computer-readable media 2220 in a server computer while another portion of program instructions 2218 can be located in computer-readable media 2220 located in a set of client computers.

The different components illustrated for data processing system 2200 are not meant to provide architectural limitations to the manner in which different embodiments can be implemented. In some illustrative examples, one or more of the components may be incorporated in or otherwise form a portion of, another component. For example, memory 2206, or portions thereof, may be incorporated in processor unit 2204 in some illustrative examples. The different illustrative embodiments can be implemented in a data processing system including components in addition to or in place of those illustrated for data processing system 2200. Other components shown in FIG. 22 can be varied from the illustrative examples shown. The different embodiments can be implemented using any hardware device or system capable of running program instructions 2218.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Thus, illustrative examples provide a method, apparatus, system, and computer program product for pointing an electromagnetic beam such as a laser beam to detect an object such as a satellite. In one illustrative example, a method points a laser beam. The laser beam is directed at a central location in a search area in which a satellite is expected to be located. The laser beam is moved in a path from the central location to an outer location. A number of scan parameters is adjusted during movement of the laser beam on the path. The adjustment of one or more of the scan parameters enables performing the scan to locate an object in the search area more quickly as compared to currently used techniques.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A laser beam transmission system comprising:
a laser beam system configured to transmit a laser beam; and
a controller configured to control the laser beam system to:
direct the laser beam at a central location in a search area in which a satellite is expected to be located;
move the laser beam on a path from the central location to an outer location; and
adjust a number of scan parameters during movement of the laser beam on the path.

2. The laser beam transmission system of claim 1, wherein in moving the laser beam on the path from the central location, the controller is configured to control the laser beam system to:
move the laser beam on the path from the central location to the outer location with a continuous movement.

3. The laser beam transmission system of claim 1, wherein in adjusting the number of scan parameters, the controller is configured to control the laser beam system to:
change a scan speed during a movement of the laser beam on the path.

4. The laser beam transmission system of claim 1, wherein the path has a spiral path and wherein in adjusting the number of scan parameters, the controller is configured to:
decrease an overlap during a movement of the laser beam on the spiral path.

5. The laser beam transmission system of claim 1, wherein in adjusting the number of scan parameters, the controller is configured to:
increase a beam divergence of the laser beam during a movement of the laser beam on the path.

6. The laser beam transmission system of claim 1, wherein in moving the laser beam on the path, the controller is configured to:
move the laser beam on the path from the central location to the outer location in steps.

7. The laser beam transmission system of claim 6, wherein the path is a spiral path and wherein in adjusting the number of scan parameters, the controller is configured to:
decrease an overlap during a movement of the laser beam on the spiral path.

8. The laser beam transmission system of claim 6, wherein in adjusting the number of scan parameters, the controller is configured to:
increase a beam divergence of the laser beam during a movement of the laser beam on the path.

9. The laser beam transmission system of claim 1, wherein the controller is configured to control the laser beam system to:
establish communications with the satellite in response to receiving a confirmation that the satellite has received the laser beam.

10. The laser beam transmission system of claim 1, wherein the number of scan parameters is selected from at least one of a scan speed, an overlap, or a beam divergence.

11. The laser beam transmission system of claim 1, wherein the path is selected from at least one of a continuous path or a spiral path.

12. An electromagnetic beam transmission system comprising:
an electromagnetic beam system configured to transmit an electromagnetic beam; and
a controller configured to control the electromagnetic beam transmission system to:
direct the electromagnetic beam at a central location in a search area in which an object is expected to be located;
move the electromagnetic beam on a path from the central location to an outer location; and
adjust a number of scan parameters during movement of the electromagnetic beam on the path.

13. The electromagnetic beam transmission system of claim 12, wherein in moving the electromagnetic beam on the path from the central location to the outer location, the controller is configured to control the electromagnetic beam system to:
move the electromagnetic beam on the path from the central location to the outer location with a continuous movement.

14. The electromagnetic beam transmission system of claim 12, wherein in moving the electromagnetic beam on the path from the central location to the outer location, the controller is configured to control the electromagnetic beam system to:
move the electromagnetic beam on the path from the central location to the outer location in steps.

15. The electromagnetic beam transmission system of claim 12, wherein the electromagnetic beam is selected from a group comprising a laser beam, a radio frequency beam, or a microwave beam.

16. The electromagnetic beam transmission system of claim 12, wherein the path is selected from at least one of a continuous path or a spiral.

17. The electromagnetic beam transmission system of claim 12, wherein the number of scan parameters is selected from at least one of a speed of an electromagnetic beam movement of the electromagnetic beam, an amount of overlap between spirals in a spiral path, a scan speed, or a beam divergence.

18. The electromagnetic beam transmission system of claim 12, wherein the object is selected from a group comprising a platform, a stationary platform, a land-based structure, an aquatic-based structure, a space-based structure, an aircraft, a vehicle controlled by an artificial intelligence system, a commercial aircraft, a rotorcraft, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a spacecraft, a space station, a satellite, a submarine, an automobile, a power plant, a bridge, a dam, a house, a manufacturing facility, or a building.

19. A method for pointing a laser beam, the method comprising:
directing the laser beam at a central location in a search area in which a satellite is expected to be located;
moving the laser beam in a path from the central location to an outer location; and
adjusting a number of scan parameters during movement of the laser beam on the path.

20. A method for pointing an electromagnetic beam, the method comprising:
directing the electromagnetic beam at a central location in a search area in which an object is expected to be located;
moving the electromagnetic beam on a path from the central location to an outer location; and
adjusting a number of scan parameters during movement of the electromagnetic beam on the path.
